(19) United States
(12) Patent Application Publication
(10) Pub. No.: US 2012/0090729 A1
(43) Pub. Date: Apr. 19, 2012

(54) METHOD FOR FUELING RAIL SYSTEM FUEL TENDER

(76) Inventors: Paul NICHINI, Lansdale, PA (US); Ross Rowland, Sackets Harbor, NY (US)

(21) Appl. No.: 12/904,292

(22) Filed: Oct. 14, 2010

(51) Int. Cl. B67D 7/00

(52) U.S. Cl. 141/2

(57) ABSTRACT

A method for fueling a rail system fuel tender which comprises a chassis and one or more fuel containers, with each fuel container adapted to contain a quantity of pressurized fuel, where the method comprises storing fuel at a fuel source storage facility located distant from the fuel tender, delivering fuel by a fuel delivery means from the fuel source storage facility to the fuel tender, and fueling the fuel tender by a fuel filling means.

### BACKGROUND OF THE INVENTION

1. Technical Field

The invention relates generally to the field of railroad refueling systems. More specifically, the invention is directed to an improved method for fueling rail system fuel tenders adapted to run on railroad rails as part of a train comprising at least one locomotive for which the improved fuel tender provides fuel.

2. Description of Prior Art

Railroad fuel tenders are well known in the art. From the earliest coal cars which were coupled to steam locomotive engines to the diesel tankers used more recently, separate vehicles have been employed to transport the fuel used by the locomotives powering trains. While locomotives have traditionally been fueled by oil or diesel, the use of natural gas is increasing. Natural gas is a cleaner burning fuel than oil or diesel and is less costly in many markets, making it an attractive alternative fuel. It may be used in the form of compressed natural gas or liquid natural gas. Engines that operate on hydrogen fuel are also known. All of these environmentally sustainable fuel types are used under pressure.

Improved fuel tenders that are adapted to fuel locomotives which run on pressurized fuel, for example, the improved rail system fuel tender disclosed in U.S. patent application Ser. No. 12/899,670 (Oct. 7, 2010, to Nichini, et al.), which Applicant hereby incorporates by reference in its entirety, have unique fueling needs as compared with traditional fuel tenders carrying non-pressurized fuel. While fuel tenders carrying oil or diesel may be fueled directly from tanks located at a rail yard, fuel tenders carrying pressurized fuel cannot be fueled directly from storage tanks, which typically contain low pressure fuel, but rather the fuel must first be pressurized before the fuel tender can be refueled. There is therefore a need for an improved method for fueling rail system fuel tenders which carry pressurized fuel.

It is therefore an objective of the present invention to provide an improved method for fueling rail system fuel tenders which carry pressurized fuel.

It is a further objective of the present invention to provide an improved method for fueling rail system fuel tenders which provides flexible means for delivering fuel from a distant fuel storage location to the rail yard.

It is yet a further objective of the present invention to provide an improved method for fueling rail system fuel tenders which provides flexible means for delivering fuel into the fuel tender.

It is yet a further objective of the present invention to provide an improved method for fueling rail system fuel tenders which provides a means for delivering fuel to fuel tenders having independently installable and removable fuel containers.

Other objects of the present invention will be readily apparent from the description that follows.

### SUMMARY OF THE INVENTION

The improved method for fueling a rail system fuel tender of the present invention is adapted to provide fuel to an improved fuel tender having one or more fuel containers, each fuel container being adapted to contain a quantity of fuel.

In one embodiment the method operates on a fuel source storage facility located distant from the fuel tender, a fuel delivery means adapted to convey fuel from the fuel source storage facility to the fuel tender, and a fuel filling means that is adapted to place fuel into the fuel tender. The method comprises the steps of storing a quantity of fuel in the fuel source storage facility, delivering the fuel by the fuel delivery means to the fuel tender, and fueling the fuel tender by the fuel filling means,.

The fuel delivery means may be a low or a high pressure fuel pipeline or an over the road fuel tanker truck. In such embodiments there may be a compressor means to pressurize the fuel prior to refueling the fuel tender, if needed. The compressor means may be located at the fuel source storage facility or at the fuel filling means. In yet another embodiment the compressor means comprises a plurality of cascade storage tanks, with each cascade storage tank coupled with a compressor such that pressurized fuel is transferred from the cascade storage tanks either to the fuel delivery means or directly to the fuel tender. In an alternate variant, the fuel delivery means comprises multiple high pressure cylinders, which are placed onto an over the road truck and transported to the fuel tender. In this embodiment the fuel source storage facility comprises a plurality of cascade storage tanks, with each cascade storage tank coupled with a compressor such that pressurized fuel is transferred from the cascade storage tanks to the multiple high pressure cylinders. The fuel filling means is a device, such as a crane, that can place the high pressure cylinders onto the fuel tender.

In another embodiment the method operates on a fuel source storage facility located distant from the fuel tender, a fuel destination storage facility located proximate to the fuel tender, a fuel delivery means adapted to convey fuel from the fuel source storage facility to the fuel destination storage facility, and a fuel filling means that is adapted to place fuel from the fuel destination storage facility into the fuel tender. The method comprises the steps of storing a quantity of fuel in the fuel source storage facility, delivering the fuel by the fuel delivery means to the fuel destination storage facility, and fueling the fuel tender by the fuel filling means.

In yet another embodiment the method operates on a fuel storage facility located proximate to the fuel tender and a fuel filling means that is adapted to place fuel from the fuel storage facility into the fuel tender. The method comprises the steps of storing a quantity of fuel in a fuel storage facility and fueling the fuel tender by the fuel filling means.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims incorporated herein.

### DESCRIPTION OF THE DRAWINGS

FIG. 1 is a plan side view of the fuel tender of the improved method for fueling a rail system fuel tender.

FIG. 2 is a schematic depiction of one embodiment of the improved method for fueling a rail system fuel tender of the present invention whereby the fuel delivery means is a low pressure pipeline and the fuel is pressurized by a compressor coupled to a plurality of cascade storage tanks located proximate to the fuel filling means.

FIG. 3 is a schematic depiction of another embodiment of the improved method for fueling a rail system fuel tender of the present invention whereby the fuel is pressurized by a compressor coupled to a plurality of cascade storage tanks located proximate to the fuel source storage facility and the fuel delivery means is an over the road tanker truck.

FIG. 4 is a schematic depiction of yet another embodiment of the improved method for fueling a rail system fuel tender of the present invention whereby the fuel delivery means is an over the road tanker truck and the fuel is pressurized by a compressor coupled to a plurality of cascade storage tanks located proximate to the fuel filling means.

FIG. 5 is a schematic depiction of yet another embodiment of the improved method for fueling a rail system fuel tender of the present invention whereby the fuel delivery means is an over the road truck capable of transporting multiple high pressure cylinders, and the fuel filling means is a crane capable of lifting the high pressure cylinders from the truck and onto the fuel tender.

FIG. 6 is a schematic depiction of one embodiment of the improved method for fueling a rail system fuel tender of the present invention whereby the fuel delivery means is a low pressure pipeline which delivers fuel from a distant fuel source storage facility to a fuel destination storage facility proximate to the fuel tender and the fuel is pressurized by a compressor coupled to a plurality of cascade storage tanks located proximate to the fuel filling means.

FIG. 7 is a schematic depiction of another embodiment of the improved method for fueling a rail system fuel tender of the present invention whereby the fuel delivery means is an over the road tanker truck which delivers fuel from a distant fuel source storage facility to a fuel destination storage facility proximate to the fuel tender and the fuel is pressurized by a compressor coupled to a plurality of cascade storage tanks located proximate to the fuel filling means.

FIG. 8 is a schematic depiction of yet another embodiment of the improved method for fueling a rail system fuel tender of the present invention whereby the fuel storage facility is located proximate to the fuel tender and the fuel filling means is adapted to place pressurized fuel via a refueling manifold into multiple high pressure cylinders located on the fuel tender and the fuel is pressurized by a compressor coupled to a plurality of cascade storage tanks located proximate to the fuel filling means.

### DETAILED DESCRIPTION OF THE INVENTION

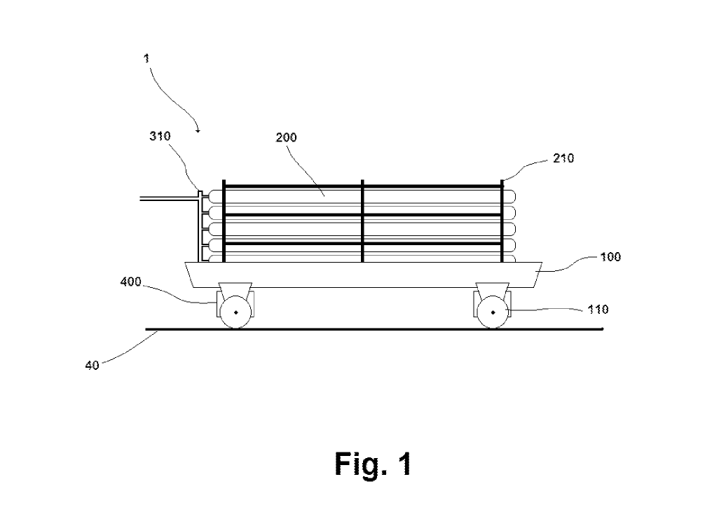

The present invention discloses an improved method for fueling a rail system fuel tender 1, where the fuel tender 1 is adapted to fuel locomotives having engines which run on pressurized fuel, such as compressed natural gas, liquid natural gas, propane, natural gas, hydrogen, and the like. Such fuel tenders 1 comprise a chassis 100 having integrated therewith at least two pairs of wheels 110 suitably adapted to allow the fuel tender 1 to engage with and move about railroad rails 40, and one or more fuel containers 200, each fuel container 200 being suitably adapted to contain a quantity of pressurized fuel. See FIG. 1. In the preferred embodiments each of the fuel containers 200 is a high pressure cylinder suitably adapted to contain fuel pressurized to at least 500 psi and as much as 5000 psi. In the most preferred embodiments the cylinders 200 may contain fuel pressurized to between 3200 psi and 3600 psi. An example of such a fuel cylinder 200 is the 3AAX-2900 made by FIBA Technologies, Inc. The use of standardized fuel cylinders 200 allows for lower costs, as well as compliance with Department of Transportation regulations and over-the-road transportation capabilities. However, any type of fuel container 200 may be used, provided it is capable of containing pressurized fuel.

The fuel tender 1 may further comprise a refueling manifold 310. See FIG. 1. The refueling manifold 310 is in connection with each of the plurality of containers 200 and is suitably adapted to allow each of the fuel containers 200 to be filled with fuel. In one embodiment the refueling manifold 310 allows the fuel containers 200 to be filled in sequence, each fuel container 200 being filled with fuel independently of each other fuel container 200; in another embodiment the refueling manifold 310 allows multiple fuel containers 200 to be filled simultaneously. The refueling manifold 310 is configured using piping, valving, conduits, and the like as is well known in the art. In yet another embodiment multiple refueling manifolds 310 may be used, with each refueling manifold 310 being in connection with only some of the fuel containers 200. For example, a fuel tender 1 having forty fuel containers 200 may have twenty of the fuel containers 200 in connection with one refueling manifold 310 and the remaining twenty fuel containers 200 in connection with another refueling manifold 310. In this embodiment, the aggregate of the refueling manifolds 310 is in connection with the aggregate of the fuel containers 200. Multiple refueling manifolds 310 allow for a “cascade” or group refueling, decreasing the time needed to refuel a fuel tender 1.

The fuel tender 1 may also comprise a propulsion mechanism 400, with the propulsion mechanism 400 integrated with the chassis 100 and capable of propelling the fuel tender 1. See FIG. 1. In one embodiment the propulsion mechanism 400 comprises one or more electric motors. In the preferred embodiment the one or more electric motors of the propulsion mechanism 400 are traction motors capable of driving the wheels 110 of the chassis 100. An alternative embodiment of the propulsion mechanism 400 of the fuel tender 1 comprises one or more hydraulic motors to propel the fuel tender 1. Alternatively, the fuel tender 1 may be unpowered.

In one embodiment, the improved method for fueling a rail system fuel tender 1 of the present invention comprises the following steps:
A. store a quantity of fuel in a fuel source storage facility 510, said fuel source storage facility 510 suitably adapted to store said fuel until said fuel is needed to refuel said fuel tender 1, said fuel tender 1 being located distant from said fuel source storage facility 510;
B. deliver said fuel by a fuel delivery means 600 to the fuel tender 1, said fuel delivery means 600 being suitably adapted to convey fuel from the fuel source storage facility 510 to the fuel tender 1; and
C. fuel the fuel tender 1 by a fuel filling means 700, said fuel filling means 700 suitably adapted to place fuel from the fuel delivery means 600 into the fuel tender 1.

The fuel source storage facility 510 of Step A is located distant from the fuel tender 1 and is suitably adapted to store a quantity of fuel. The fuel source storage facility 510 is typically a centralized tank farm which is located near a fuel source, such as a liquid natural gas terminal or pipeline. The fuel tanks typically store fuel in a state of lower pressure than will be used by the fuel tender 1. The fuel source storage facility 510 may be used to provide fuel to multiple different locations, each of which may be used to fuel the fuel tenders 1. An example may be a single fuel source storage facility 510 which provides fuel to various rail yards in a given region.

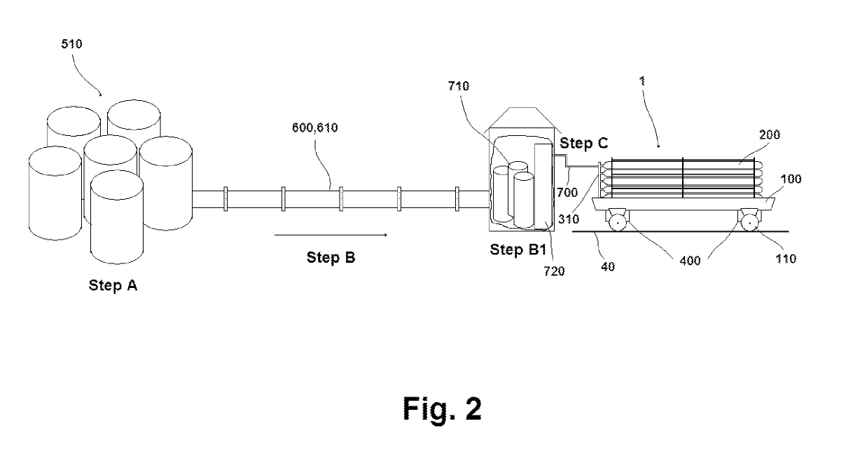

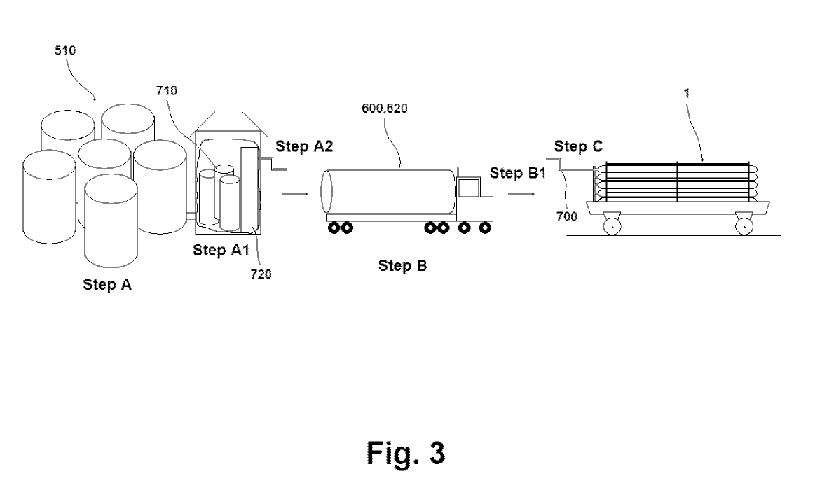

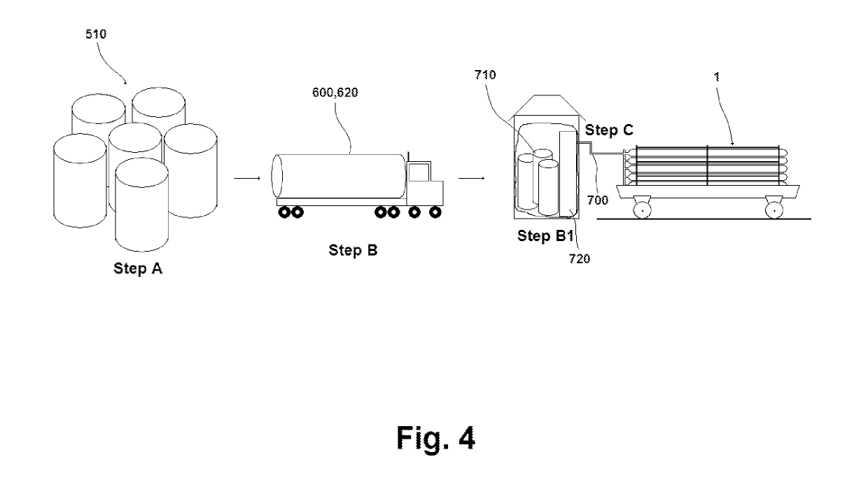

The fuel delivery means 600 of Step B is any means suitably adapted to convey fuel from the fuel source storage facility 510 to the location of the fuel tender 1. In one embodiment the fuel delivery means 600 is a low pressure pipeline 610. See FIG. 2. In another embodiment the fuel delivery means 600 is a high pressure pipeline. In yet another embodiment the fuel delivery means 600 is an over the road tank truck 620. See FIGS. 3 and 4. Other means known in the art are also contemplated for transporting fuel from the fuel source storage facility 510 to the location of the fuel tender 1.

The fuel filling means 700 of Step C is adapted to place fuel into the fuel tender 1. The fuel filling means 700 may comprise piping, hoses, or any other appropriate means known in the art. The fuel filling means 700 may be adapted to interface with one or more refueling manifolds 310 of the fuel tender 1.

Because the fuel may be delivered by the fuel delivery means 600 at a lower pressure than is to be used by the fuel tender 1, there may be located at the fuel source storage facility 510 a compressor means to pressurize the fuel prior to placing it onto the fuel tender 1. The compressor means may be used, for example, to pressurize the fuel that is loaded into an over the road tank truck 620, which then transports high pressure fuel to the location of the fuel tender 1. The compressor means may be any compressor known in the art suitably adapted to pressurize the fuel.

The improved method of the present invention therefore may further comprise the following step:
A1. pressurize said fuel using a compressor located at the fuel source storage facility 510;
wherein Step A1 is performed after Step A and before Step B.

Where the fuel delivery means comprises a tank truck, the method of the present invention may further comprise the following steps:
A2. place said fuel pressurized in Step A1 into said tank truck;
B1. remove said fuel from said tank truck;
wherein Step A1 is performed after Step A and before Step B, and Step B1 is performed after Step B and before Step C.

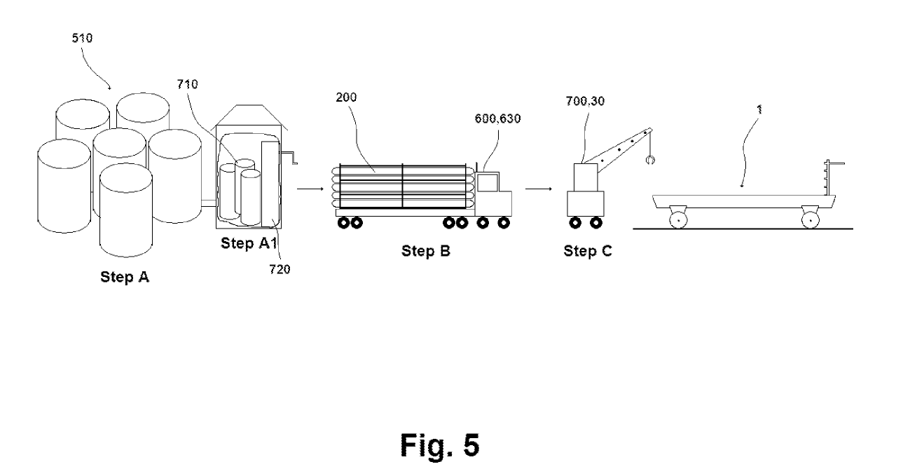

Alternatively, there may be located at the fuel source storage facility 510 a plurality of cascade storage tanks 710, with each cascade storage tank 710 coupled with a compressor 720 such that pressurized fuel is transferred from the cascade storage tanks 710 to the fuel containers 200. See FIGS. 3 and 5.

In this embodiment the improved method of the present invention may further comprise the following step:
A1. use the compressors 720 coupled to the cascade storage tanks 710 to pressurize said fuel from the fuel source storage facility 510;
wherein Step A1 is performed after Step A and before Step B.

Where the fuel delivery means comprises a tank truck, the method of the present invention may further comprise the following steps:
A2. place said fuel pressurized in Step A1 into said tank truck;
B1. remove said fuel from said tank truck;
wherein Step A1 is performed after Step A and before Step B, Step A2 is performed after Step A1 and before Step B, and Step B1 is performed after Step B and before Step C. See FIG. 3.

In yet another embodiment, the fuel filling means 700 may comprise a compressor means located proximate to the fuel tender 1 to pressurize the fuel prior to placing it onto the fuel tender 1. This may be any compressor known in the art suitably adapted to pressurize the fuel.

In this embodiment the improved method of the present invention may further comprise the following step:
B1. pressurize said fuel using a compressor located proximate to the fuel filling means 700;
wherein Step B1 is performed after Step B and before Step C.

In yet another embodiment, the fuel filling means 700 may comprise a plurality of cascade storage tanks 710, with each cascade storage tank 710 coupled with a compressor 720 such that pressurized fuel is transferred from the cascade storage tanks 710 to the fuel containers 200. See FIGS. 2 and 4.

In this embodiment the improved method of the present invention may further comprise the following step:
B1. use the compressors 720 coupled to the cascade storage tanks 710 to pressurize said fuel delivered from the fuel source storage facility 510;
wherein Step B1 is performed after Step B and before Step C.

Where the fuel delivery means 600 comprises a tank truck 620, the improved method of the present invention further comprises the following steps:
A1. place said fuel from the fuel source storage facility 510 into said tank truck 620;
B1. remove said fuel from said tank truck 620;
wherein Step A1 is performed after Step A and before Step B, and Step B1 is performed after Step B and before Step C.

In an alternative embodiment, the fuel containers 200 of the fuel tender 1 are removable from and installable onto the fuel tender 1. In this embodiment the fuel containers 200 are preferably high pressure cylinders. The fuel delivery means 600 of this embodiment comprises a plurality of the fuel containers 200 and an over the road truck 630 suitably adapted to transport the fuel containers 200.

In this embodiment the improved method of the present invention further comprising the following steps:
A1. use a compressor to pressurize said fuel from the fuel source storage facility 510;
A2. place said pressurized fuel from the fuel source storage facility 510 into said plurality of fuel containers 200; and
A3. place said plurality of fuel containers 200 onto said truck 630;
wherein Steps A1 and A2 are performed after Step A and before Step B and step A3 being performed at any time before Step B, and said fuel filling means 700 of Step C comprises one or more devices suitably adapted to lift said fuel containers from said truck and onto said fuel tender, such as a crane 30 or a forklift.

Alternatively, the fuel source storage facility 510 may comprise a plurality of cascade storage tanks 710, with each cascade storage tank 710 coupled with a compressor 720 such that pressurized fuel is transferred from the cascade storage tanks 710 to the fuel containers 200. This alternative embodiment is useful in situations where there is little or no infrastructure for transporting fuel from the fuel source storage facility 510 to the fuel tender 1, or where the fuel tender 1 refueling site itself has little infrastructure. This allows fuel tenders 1 to be refueled at remote locations, thereby extending the train's range.

In this embodiment the improved method of the present invention further comprises the following steps:
A1. use the compressors 720 coupled to the cascade storage tanks 710 to pressurize said fuel from the fuel source storage facility 510;
A2. place said pressurized fuel from the fuel source storage facility 510 into said plurality of fuel containers 200; and
A3. place said plurality of fuel containers 200 onto said truck 510;
wherein Steps A1 and A2 are performed after Step A and before Step B and step A3 being performed at any time before Step B, and said fuel filling means 700 of Step C comprises one or more devices suitably adapted to lift said fuel containers from said truck and onto said fuel tender, such as a crane 30 or a forklift. See FIG. 5.

In embodiments of the improved method of the present invention in which one or more refueling manifolds 310 are used, the fuel filling means 700 of Step C is in connection with the fuel delivery means 600 and with one or more of the refueling manifolds 310. Fuel is placed from the fuel delivery means 600 into the fuel tender 1 through the one or more refueling manifolds 310. In such embodiments where the fuel delivery means 600 comprises a plurality of high pressure cylinders 200 and a truck 630 suitably adapted to transport said fuel containers 200, a plurality of cascade storage tanks 710, with each said cascade storage tank 710 coupled with a compressor 720 such that pressurized fuel is transferred from the cascade storage tanks 710 to the one or more fuel containers 200 may be used.

Such method further comprising the following steps:
A1. use the compressors 720 coupled to the cascade storage tanks 710 to pressurize said fuel from the fuel source storage facility 510;
A2. place said pressurized fuel from the fuel source storage facility 510 into said plurality of fuel containers 200 through said one or more refueling manifolds 310; and
A3. place said plurality of fuel containers 200 onto said truck 630;
wherein Steps A1 through A3 are performed after Step A and before Step B, and said fuel filling means 700 of Step C comprises one or more devices suitably adapted to lift said fuel containers 200 from said truck 630 and onto said fuel tender 1.

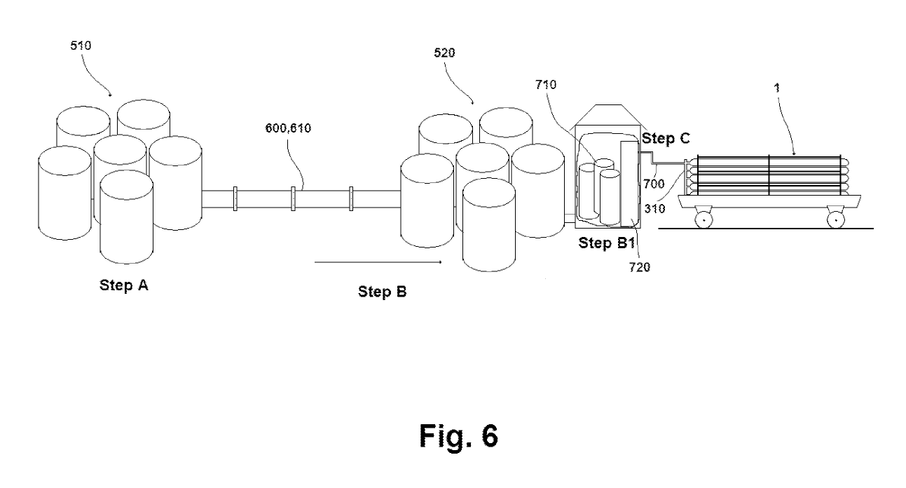

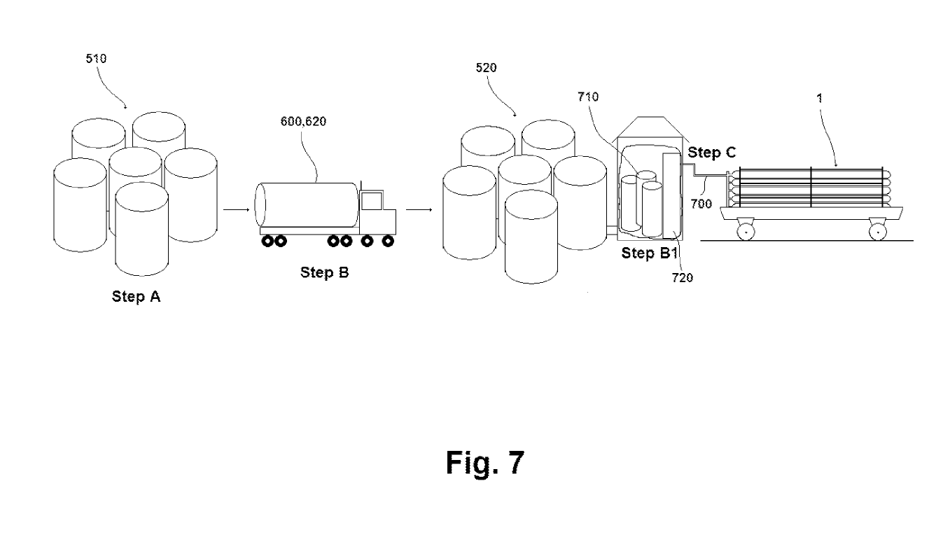

In another embodiment of the improved method of the present invention, a fuel destination storage facility 520 may be used, in addition to the fuel source storage facility 510, the fuel delivery means 600, and the fuel filling means 700, as described above. See FIGS. 6 and 7. In this embodiment the fuel destination storage facility 520 is located proximate to the fuel tender 1. The fuel destination storage facility 520 is typically a centralized tank farm. The fuel tanks typically store fuel in a state of lower pressure than will be used by the fuel tender 1. The fuel destination storage facility 520 is typically located within a rail yard. The fuel delivery means 600 in this embodiment is suitably adapted to convey fuel from the fuel source storage facility 510 to the fuel destination storage facility 520, and may be a high or low pressure pipeline 610, see FIG. 6, an over the road tank truck 620, see FIG. 7, or other means known in the art for transporting fuel from the fuel source storage facility 510 to the fuel destination storage facility 520. The fuel filling means 700 is adapted to place fuel from the fuel destination storage facility 520 into the fuel tender 1, as described above.

The method comprises the following steps:
A. store a quantity of fuel in a fuel source storage facility 510, said fuel source storage facility 510 suitably adapted to store said fuel until said fuel is needed to refuel said fuel tender 1, said fuel tender 1 being located distant from said fuel source storage facility 510;
B. deliver said fuel by a fuel delivery means 600, said fuel delivery means 600 being suitably adapted to convey fuel from the fuel source storage facility 510 to a fuel destination storage facility 520, said fuel destination storage facility 520 suitably adapted to store said quantity of fuel until said fuel is needed to refuel said fuel tender 1, said fuel tender 1 being located proximate to said fuel destination storage facility 520; and
C. refuel the fuel tender 1 by a fuel filling means 700, said fuel filling means 700 suitably adapted to place fuel from the fuel destination storage facility 520 into the fuel tender 1.

As described above, the fuel filling means 700 of Step C may be in connection with the fuel delivery means 600 and with one or more refueling manifolds 310, with the fuel being placed from the fuel destination storage facility 520 into the fuel tender 1 through said one or more refueling manifolds 310.

Also, the fuel destination storage facility 520 may comprise a compressor means suitably adapted to pressurize fuel as described above. The compressor means could be any compressor known in the art suitably adapted to pressurize fuel, or a plurality of cascade storage tanks 710, with each said cascade storage tank 710 coupled with a compressor 720. The fuel filling means 700 of Step C then places pressurized fuel from the fuel destination storage facility 520 into the one or more fuel containers 200.

This embodiment of the method further comprising the following step:
B1. pressurize said fuel;
wherein Step B1 is performed after Step B and before Step C.

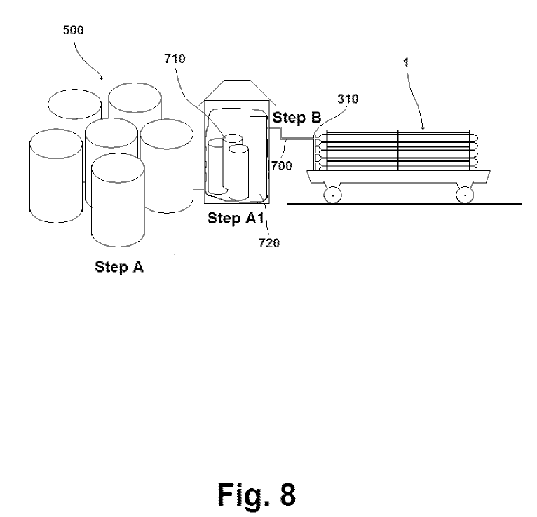

In yet another embodiment of the improved method of the present invention, there is a fuel storage facility 500 and a fuel filling means 700. See FIG. 8. In this embodiment the fuel storage facility 500 is adapted to store a quantity of fuel and is located proximate to the fuel tender 1. The fuel filling means 700 is adapted to place fuel from the fuel storage facility 500 into the fuel tender 1, as described above.

The method of this embodiment comprises the following steps:
A. store a quantity of fuel in a fuel storage facility 500, said fuel storage facility 500 suitably adapted to store said fuel until said fuel is needed to refuel said fuel tender 1, said fuel tender 1 being located proximate to said fuel storage facility 500; and
B. fuel the fuel tender by a fuel filling means 700, said fuel filling means 700 suitably adapted to place fuel from the fuel storage facility 500 into the fuel tender 1.

As described above, the fuel filling means 700 of Step B may be in connection with the fuel storage facility 500 and with one or more refueling manifolds 310, with the fuel being placed from the fuel storage facility 500 into the fuel tender 1 through said one or more refueling manifolds 310.

Also, the fuel storage facility 500 may comprise a compressor means suitably adapted to pressurize fuel as described above. The compressor means could be any compressor known in the art suitably adapted to pressurize fuel or a plurality of cascade storage tanks 710, with each said cascade storage tank 710 coupled with a compressor 720. The fuel filling means 700 of Step B then places pressurized fuel from the fuel storage facility 500 into the one or more fuel containers 200.

The method of this embodiment further comprising the following step:
A1. pressurize said fuel;
wherein Step A1 is performed after Step A and before Step B.

What has been described and illustrated herein is a preferred embodiment of the invention along with some it its variations. The terms, descriptions and figures used herein are set forth by way of illustration only and are not meant as limitations. Those skilled in the art will recognize that many variations are possible within the spirit and scope of the invention as defined in the following claims in which all terms are meant in their broadest, reasonable sense unless otherwise indicated.

I claim:

1. A method for fueling a rail system fuel tender, said fuel tender comprising a chassis, said chassis having integrated therewith at least two pairs of wheels suitably adapted to allow the fuel tender to engage with and move about railroad rails, said fuel tender further comprising one or more fuel containers, each said fuel container suitably adapted to contain a quantity of fuel,
said method comprising the following steps:
A. store a quantity of fuel in a fuel source storage facility, said fuel source storage facility suitably adapted to store said fuel until said fuel is needed to refuel said fuel tender, said fuel tender being located distant from said fuel source storage facility;
B. deliver said fuel by a fuel delivery means to the fuel tender, said fuel delivery means being suitably adapted to convey fuel from the fuel source storage facility to the fuel tender; and
C. fuel the fuel tender by a fuel filling means, said fuel filling means suitably adapted to place fuel from the fuel delivery means into the fuel tender.

2. The method of claim 1 further comprising the following steps:
A1. pressurize said fuel using a compressor located at the fuel source storage facility;
wherein Step A1 is performed after Step A and before Step B.

3. The method of claim 2 wherein said fuel delivery means comprises a tank truck, said method further comprising the following steps:
A2. place said fuel pressurized in Step A1 into said tank truck;
B1. remove said fuel from said tank truck;
wherein Step A2 is performed after Step A1 and before Step B, and Step B1 is performed after Step B and before Step C.

4. The method of claim 1 wherein said fuel storage facility comprises a plurality of cascade storage tanks, with each said cascade storage tank coupled with one or more compressors, said method further comprising the following steps:
A1. use the one or more compressors coupled to the cascade storage tanks to pressurize said fuel from the fuel source storage facility;
wherein Step A1 is performed after Step A and before Step B.

5. The method of claim 4 wherein said fuel delivery means comprises a tank truck, said method further comprising the following steps:
A2. place said fuel pressurized in Step A1 into said tank truck;
B1. remove said fuel from said tank truck;
wherein Step A2 is performed after Step A1 and before Step B, and Step B1 is performed after Step B and before Step C.

6. The method of claim 1 further comprising the following steps:
B1. pressurize said fuel using a compressor located proximate to the fuel filling means;
wherein Step B1 is performed after Step B and before Step C.

7. The method of claim 1 wherein a plurality of cascade storage tanks, with each said cascade storage tank coupled with one or more compressors, are located proximate to the fuel filling means, said method further comprising the following steps:
B1. use the one or more compressors coupled to the cascade storage tanks to pressurize said fuel delivered from the fuel source storage facility;
wherein Step B1 is performed after Step B and before Step C.

8. The method of claim 1 wherein said fuel delivery means is a pipeline.

9. The method of claim 1 wherein said fuel delivery means comprises a tank truck, said method further comprising the following steps:
A1. place said fuel from the fuel source storage facility into said tank truck;
B1. remove said fuel from said tank truck;
wherein Step A1 is performed after Step A and before Step B, and Step B1 is performed after Step B and before Step C.

10. The method of claim 1 wherein said fuel delivery means comprises a plurality of said fuel containers, each of said plurality of fuel containers being a high pressure cylinder suitably adapted to contain fuel pressurized to at least 500 psi, and a truck suitably adapted to transport said fuel containers, said method further comprising the following steps:
A1. use a compressor to pressurize said fuel from the fuel source storage facility;
A2. place said pressurized fuel from the fuel source storage facility into said plurality of fuel containers; and
A3. place said plurality of fuel containers onto said truck;
wherein Steps A1 and A2 are performed after Step A and before Step B and step A3 is performed at any time before Step B, and
said fuel filling means of Step C comprises one or more devices suitably adapted to lift said fuel containers from said truck and onto said fuel tender.

11. The method of claim 1 wherein
said fuel source storage facility comprises a plurality of cascade storage tanks, with each said cascade storage tank coupled with one or more compressors, and
said fuel delivery means comprises a plurality of said fuel containers, each of said plurality of fuel containers being a high pressure cylinder suitably adapted to contain fuel pressurized to at least 500 psi, and a truck suitably adapted to transport said fuel containers,
said method further comprising the following steps:
A1. use the one or more compressors coupled to the cascade storage tanks to pressurize said fuel from the fuel source storage facility;
A2. place said pressurized fuel from the fuel source storage facility into said plurality of fuel containers; and
A3. place said plurality of fuel containers onto said truck;
wherein Steps A1 and A2 are performed after Step A and before Step B and step A3 is performed at any time before Step B, and
said fuel filling means of Step C comprises one or more devices suitably adapted to lift said fuel containers from said truck and onto said fuel tender.

12. The method of claim 1 wherein said fuel tender comprises a plurality of fuel containers and one or more refueling manifolds, each said refueling manifold being in connection with one or more of said plurality of fuel containers,
wherein the fuel filling means of Step C is in connection with said fuel delivery means and with said one or more refueling manifolds, with fuel being placed from the fuel delivery means into the fuel tender through said one or more refueling manifolds.

13. The method of claim 1 wherein
said fuel delivery means comprises
a plurality of said fuel containers, each of said plurality of fuel containers being a high pressure cylinder suitably adapted to contain fuel pressurized to at least 500 psi,
one or more refueling manifolds, each said refueling manifold being in connection with one or more of said plurality of fuel containers, and
a truck suitably adapted to transport said fuel containers; and p1 said fuel source storage facility comprises
a plurality of cascade storage tanks, with each said cascade storage tank coupled with one or more compressors such that pressurized fuel is transferred from the cascade storage tanks to the one or more fuel containers;
said method further comprising the following steps:
A1. use the one or more compressors coupled to the cascade storage tanks to pressurize said fuel from the fuel source storage facility;
A2. place said pressurized fuel from the fuel source storage facility into said plurality of fuel containers through said one or more refueling manifolds; and
A3. place said plurality of fuel containers onto said truck;
wherein Steps A1 and A2 are performed after Step A and before Step B and step A3 is performed at any time before Step B, and
said fuel filling means of Step C comprises one or more devices suitably adapted to lift said fuel containers from said truck and onto said fuel tender.

14. A method for fueling a rail system fuel tender, said fuel tender comprising a chassis, said chassis having integrated therewith at least two pairs of wheels suitably adapted to allow the fuel tender to engage with and move about railroad rails, said fuel tender further comprising one or more fuel containers, each said fuel container suitably adapted to contain a quantity of pressurized fuel, with each said fuel container separately installable onto and removable from the fuel tender,
said method comprising the following steps:
A. store a quantity of fuel in a fuel source storage facility, said fuel source storage facility suitably adapted to store said fuel until said fuel is needed to refuel said fuel tender, said fuel tender being located distant from said fuel source storage facility;
B. deliver said fuel by a fuel delivery means, said fuel delivery means being suitably adapted to convey fuel from the fuel source storage facility to a fuel destination storage facility, said fuel destination storage facility suitably adapted to store said quantity of fuel until said fuel is needed to refuel said fuel tender, said fuel tender being located proximate to said fuel destination storage facility; and
C. fuel the fuel tender by a fuel filling means, said fuel filling means suitably adapted to place fuel from the fuel destination storage facility into the fuel tender.

15. The method of claim 14 wherein the fuel delivery means is a pipeline, said pipeline being in connection with the fuel source storage facility and with the fuel destination storage facility.

16. The method of claim 14 wherein the fuel delivery means comprises a tank truck, said method further comprising the following step:
A1. place said fuel from the fuel source storage facility into said tank truck;
wherein Step A1 is performed after Step A and before Step B; and
Step B further comprises removing said fuel from said tank truck and placing said fuel into said fuel destination storage facility.

17. The method of claim 14 wherein said fuel tender comprises a plurality of fuel containers and one or more refueling manifolds, each said refueling manifold being in connection with one or more of said plurality of fuel containers,
wherein the fuel filling means of Step C is in connection with said fuel delivery means and with said one or more refueling manifolds, with fuel being placed from the fuel destination storage facility into the fuel tender through said one or more refueling manifolds.

18. The method of claim 14 wherein the fuel destination storage facility comprises a compressor suitably adapted to pressurize said fuel and the fuel filling means is suitably adapted to place pressurized fuel from the fuel destination storage facility into the one or more fuel containers, said method further comprising the following step:
B1. pressurize said fuel;
wherein Step B1 is performed after Step B and before Step C.

19. The method of claim 18 wherein said fuel tender comprises a plurality of fuel containers and one or more refueling manifolds, each said refueling manifold being in connection with one or more of said plurality of fuel containers,
wherein the fuel filling means of Step C is in connection with said fuel destination storage facility and with said one or more refueling manifolds, with the fuel being placed from the fuel destination storage facility into the fuel tender through said one or more refueling manifolds.

20. The method of claim 14 wherein the fuel destination storage facility comprises a plurality of cascade storage tanks, with each said cascade storage tank coupled with one or more compressors, each said compressor suitably adapted to pressurize said fuel and the fuel filling means is suitably adapted to place pressurized fuel from the cascade storage tanks into the one or more fuel containers, said method further comprising the following step:
B1. pressurize said fuel;
wherein Step B1 is performed after Step B and before Step C.

21. The method of claim 20 wherein said fuel tender comprises a plurality of fuel containers and one or more refueling manifolds, each said refueling manifold being in connection with one or more of said plurality of fuel containers,
wherein the fuel filling means of Step C is in connection with said fuel destination storage facility and with said one or more refueling manifolds, with the fuel being placed from the fuel destination storage facility into the fuel tender through said one or more refueling manifolds.

22. The method of claim 14 wherein the fuel to be contained within each said fuel container comprises one of the following group: compressed natural gas, liquid natural gas, propane, natural gas, and hydrogen.

23. The method of claim 14 wherein said fuel tender further comprises a powered propulsion mechanism, said propulsion mechanism capable of propelling said fuel tender.

24. A method for fueling a rail system fuel tender, said fuel tender comprising a chassis, said chassis having integrated therewith at least two pairs of wheels suitably adapted to allow the fuel tender to engage with and move about railroad rails, said fuel tender further comprising one or more fuel containers, each said fuel container suitably adapted to contain a quantity of fuel, with each said fuel container separately installable onto and removable from the fuel tender,
said method comprising the following steps:
A. store a quantity of fuel in a fuel storage facility, said fuel source storage facility suitably adapted to store said fuel until said fuel is needed to refuel said fuel tender, said fuel tender being located proximate to said fuel source storage facility; and
B. fuel the fuel tender by a fuel filling means, said fuel filling means suitably adapted to place fuel from the fuel storage facility into the fuel tender.

25. The method of claim 24 wherein said fuel tender comprises a plurality of fuel containers and one or more refueling manifolds, each said refueling manifold being in connection with one or more of said plurality of fuel containers,
wherein the fuel filling means of Step B is in connection with said fuel storage facility and with said one or more refueling manifolds, with the fuel being placed from the fuel storage facility into the fuel tender through said one or more refueling manifolds.

26. The method of claim 24 wherein the fuel storage facility comprises a compressor suitably adapted to pressurize said fuel and the fuel filling means is suitably adapted to place pressurized fuel from the fuel storage facility into the one or more fuel containers, said method further comprising the following step:
A1. pressurize said fuel;
wherein Step A1 is performed after Step A and before Step B.

27. The method of claim 26 wherein said fuel tender comprises a plurality of fuel containers and one or more refueling manifolds, each said refueling manifold being in connection with one or more of said plurality of fuel containers,
wherein the fuel filling means of Step B is in connection with said fuel storage facility and with said one or more refueling manifolds, with the fuel being placed from the fuel storage facility into the fuel tender through said one or more refueling manifolds.

28. The method of claim 24 wherein the fuel storage facility comprises a plurality of cascade storage tanks, with each said cascade storage tank coupled with one or more compressors, each said compressor suitably adapted to pressurize said fuel and the fuel filling means is suitably adapted to place pressurized fuel from the cascade storage tanks into the one or more fuel containers, said method further comprising the following step:
A1. pressurize said fuel;
wherein Step A1 is performed after Step A and before Step B.

29. The method of claim 28 wherein said fuel tender comprises a plurality of fuel containers and one or more refueling manifolds, each said refueling manifold being in connection with one or more of said plurality of fuel containers,
wherein the fuel filling means of Step B is in connection with said fuel storage facility and with said one or more refueling manifolds, with the fuel being placed from the fuel storage facility into the fuel tender through said one or more refueling manifolds.

30. The method of claim 1 wherein the fuel to be contained within each said fuel container comprises one of the following group: compressed natural gas, liquid natural gas, propane, natural gas, and hydrogen.

31. The method of claim 24 wherein the fuel to be contained within each said fuel container comprises one of the following group: compressed natural gas, liquid natural gas, propane, natural gas, and hydrogen.

32. The method of claim 1 wherein said fuel tender further comprises a powered propulsion mechanism, said propulsion mechanism capable of propelling said fuel tender.

33. The method of claim 24 wherein said fuel tender further comprises a powered propulsion mechanism, said propulsion mechanism capable of propelling said fuel tender.
